(19) United States
(12) Patent Application Publication
(10) Pub. No.: US 2011/0314406 A1
(43) Pub. Date: Dec. 22, 2011

(54) ELECTRONIC READER AND DISPLAYING METHOD THEREOF

(75) Inventors: Tzu-Ming Wang, Fengshan City (TW); Kai-Cheng Chuang, Tainan City (TW)

(73) Assignee: E Ink Holdings Inc., Hsinchu City (TW)

(21) Appl. No.: 12/985,677

(22) Filed: Jan. 6, 2011

(30) Foreign Application Priority Data
Jun. 18, 2010 (TW) 099120027

(51) Int. Cl. G06F 3/048

(52) U.S. Cl. 715/776

(57) ABSTRACT

An electronic reader and a displaying method thereof are respectively provided in the present invention. The electronic reader includes a recognition unit recognizing an identity input; and a displaying unit displaying a screen corresponding to the identity input after the recognition unit identifies the identity input. The method includes steps providing an electronic reader displaying an electronic book file; inputting an identify recognition to the electronic reader; and displaying at least one page of the electronic book file previously used by a specific user in response to the identify recognition on the electronic reader.

### FIELD OF THE INVENTION

The present invention relates to an electronic reader and displaying method thereof. More particularly to an electronic reader which can identifies different bookmarkers of various users and can display one of the pages which a specific user previously read.

### BACKGROUND OF THE INVENTION

With the growing popularity of the electronic book, the scenario that more and more people use the same electronic reader (e-book) becomes common. Currently, readers search or find out the page they intend to read through a passive bookmark or an index of the electronic book. But if the above passive bookmark can only indicate a small number of title pages or multiple users read their own electronic book in the same electronic reader, searching the page intended to read will be a laborious effort.

Therefore, the inventor thought of the idea of an improvement invention after considering the shortage of the prior art and finally invented the case of “an electronic reader and displaying method thereof”.

### SUMMARY OF THE INVENTION

The present invention provides an electronic reader and displaying method thereof. The electronic reader has an identifying device identifying the input of different users or different types by which the electronic reader displays the screen corresponding to the input.

In accordance with the first aspect of the present invention, an electronic reader is provided. The electronic reader, including: a recognition unit recognizing an identity input; and a displaying unit displaying a screen corresponding to the identity input after the recognition unit identifies the identity input.

Preferably, the electronic reader further includes a storage device used to store screens respectively corresponding to identity inputs.

Preferably, the identify input is one selected from a group consisting of a fingerprint bookmark, a voice bookmark, an image bookmark, a password bookmark and a combination thereof.

Preferably, the screen displays a last page of the electronic book file used by the specific user on the electronic reader at the last time.

Preferably, the screen displays respective last pages of electronic book files which have been read or used by the specific user on the electronic reader.

In accordance with the second aspect of the present invention, an electronic reader is provided. The electronic reader, including: a recognition unit recognizing an identity input, wherein the electronic reader outputs a signal for displaying page of an electronic book file previously read on the electronic reader by a specific user and corresponding to the identity input after the recognition unit identifies the identity input.

Preferably, the recognition unit is one selected from a group consisting of a fingerprint recognition unit, a voice recognition unit, an image recognition unit, a password recognition unit and a combination thereof.

Preferably, the identity input is one selected from a group consisting of a fingerprint, a voice, an image, a password and a combination thereof.

In accordance with the third aspect of the present invention, an electronic reader is provided. The electronic reader, including: a recognition unit recognizing an input, wherein the electronic reader outputs a signal for displaying at least one page of an electronic book file read by a specific user and corresponding to the input on the electronic reader after the recognition unit identifies the input.

Preferably, the at least one page displays a last page of the electronic book file read by the specific user on the electronic reader at the last time.

Preferably, the at least one page displays respective last pages of electronic book files which were read by the specific user on the electronic reader.

In accordance with the fourth aspect of the present invention, a method of displaying is provided. The method of displaying, including: steps of providing an electronic reader displaying an electronic book file; inputting an identify recognition to the electronic reader; and displaying at least one page of the electronic book file previously used by a specific user in response to the identify recognition on the electronic reader.

In accordance with the fifth aspect of the present invention, a method of displaying is provided. The method of displaying, including: steps of receiving an input through an electronic reader; opening the electronic reader through the input; and displaying a page of an electronic book file which was read by a specific user in response to the input, on the electronic reader.

The foregoing and other features and advantages of the present invention will be more clearly understood through the following descriptions with reference to the drawings, wherein:

### BRIEF DESCRIPTION OF THE DRAWINGS

FIG. 1 is a schematic diagram showing the electronic reader with the recognition unit according to the present invention; and

FIG. 2 is a flow chart schematically showing the embodiment of the present application.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purposes of illustration and description only; it is not intended to be exhaustive or to be limited to the precise form disclosed.

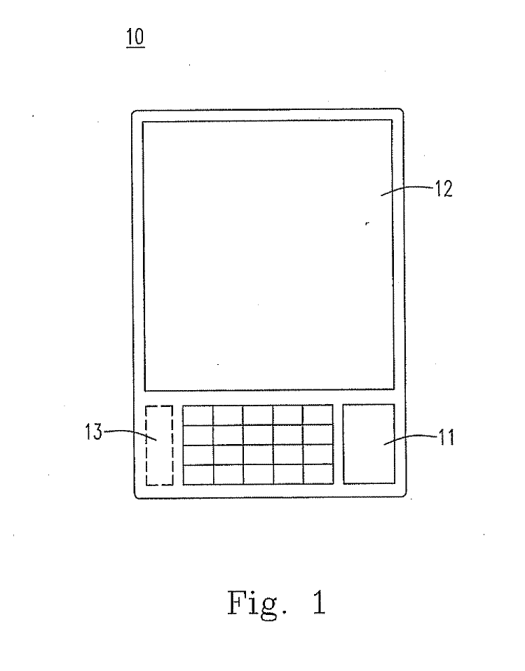

Please refer to FIG. 1, which is a schematic diagram showing the electronic reader with the recognition unit according to the present invention. The electronic reader 10, as described in FIG. 1, includes a recognition unit 11, a displaying unit 12 and a storage unit 13. Therein, a recognition unit 11 is to recognize an input which represents a specific user, so the input can be regard as an identity input. And the input can be one of a fingerprint, a voice, an image (such as an image of human face), a password or a combination thereof. The recognition unit 11 can be one of a fingerprint identification unit, a voice identification unit, a image identification unit, a password identification unit or a combination thereof.

When the recognition unit 11 receives an input, it can further recognize that the input belongs to which user. Then, the electronic reader 10 searches the frame corresponding to the input from the storage unit 13, and shows the frame through the displaying unit 12. For example, when the recognition unit 11 has received the input and identified user A from it, the displaying unit 12 shows the frame a, corresponding to user A. And the frame a displays the last page of the electronic book file which is the one that user A read it on the electronic reader 10 last time (i.e. the last page of reading last time). So that user A can rapidly continue to read the electronic book (file), the time and energy will be saved for searching the last page of last reading. Moreover, the frame a also displays respective the page or the last page of various electronic books user A previously read on the electronic reader 10, in order to make user A choices at least one of the electronic books and then read it. Besides, the frame a also can be a video frame of an animation file, a digital photograph, a menu frame, an office work frame, the frame of user A using last time or a combination thereof.

Even if the recognition unit 11 has received the input and further identified the input belonging to user B, then the displaying unit 12 shows the frame b corresponding to user B. And the frame b is the last page which was read by user B on the electronic reader 10 last time, so that user B can rapidly continue to read from where last reading. Similarly, the frame b also can be respective the last page of various electronic books which user B previously read on the electronic reader 10. Or the same as the frame a, the frame b shows a video frame of an animation file, a digital photograph, a menu frame, an office work frame, the frame of user B using last time or a combination thereof.

It needs to be emphasized that the input can be a fingerprint, a voice, an image and a password, etc. That means the input should be a fingerprint bookmark, a voice bookmark, an image bookmark and a password bookmark. When the recognition unit 11 identifies respective bookmarks of various users, the displaying unit shows the frame corresponding to the specific user. Moreover, the input also can be a turn signal. That is the electronic reader 10 which opens and makes the above-mentioned process after receiving the input for the recognition unit 11.

Besides, the storage unit 13 will be used to store identity inputs and respective frames corresponding to each identity input. So that the displaying unit 12 can immediately show the corresponding frame after the recognition unit 11 identifies which user the input belongs to.

Of course, the recognition unit 11 also can identify an input which stands for different types. For example, if the recognition unit 11 identifies that the input is the fingerprint of the thumb of user A, the displaying unit 12 shows their corresponding pages of tourism electronic books which user A has seen to offer user A options. If the recognition unit 11 identifies that the input is the fingerprint of the forefinger of user A, the displaying unit 12 shows respective drawings of animation-art of animation files which user A previously watched for the choice of user A. If the recognition unit 11 identifies that the input is the face image of user A, the displaying unit 12 shows the feature menu corresponding to user A.

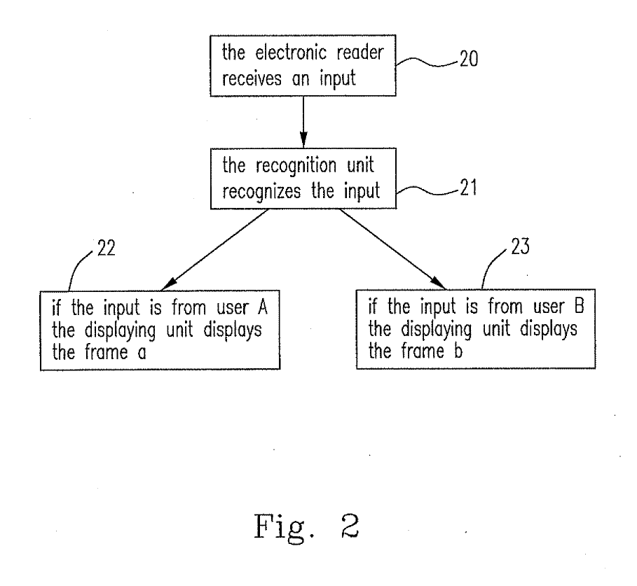

Please refer to FIG. 2, which is a flow chart of an implementation case in the present application. As showing in FIG. 2, when the electronic reader 10 has received an input (step 20), the recognition unit 11 will recognize which user the input belong to (step 21). If the input is from user A, the displaying unit 12 displays the frame a corresponding to user A (step 22). If the input is from user B, the displaying unit 12 displays the frame b corresponding to user B (step 23). Wherein the frame a and b can be any frame of the above-mentioned implement case. So that user A and user B use the same electronic reader 10 although, they can rapidly obtain the frame they want to read and/or use.

Through the above description, the electronic reader 10 provided by the present application can identify respective input from different users. So that the electronic reader 10 can directly show different user's last reading frame or specific frame. The needed time and complex will be decreased greatly for one user to search the page user wants to read, or for multi-users to search their own electronic books or the specific pages in the same electronic reader.

While the invention has been described in terms of what is presently considered to be the most practical and preferred embodiments, it is to be understood that the invention needs not be limited to the disclosed embodiments. Therefore, it is intended to cover various modifications and similar configuration included within the spirit and scope of the appended claims, which are to be accorded with the broadest interpretation so as to encompass all such modifications and similar structures.

What is claimed is:

1. An electronic reader, comprising:
a recognition unit recognizing an identity input; and
a displaying unit displaying a screen corresponding to the identity input after the recognition unit identifies the identity input.

2. The electronic reader as claimed in claim 1, further comprising a storage device used to store screens respectively corresponding to identity inputs.

3. The electronic reader as claimed in claim 1, wherein the identify input is one selected from a group consisting of a fingerprint bookmark, a voice bookmark, an image bookmark, a password bookmark and a combination thereof.

4. The electronic reader as claimed in claim 1, wherein the screen displays a last page of the electronic book file used by the specific user on the electronic reader at the last time.

5. The electronic reader as claimed in claim 1, wherein the screen displays respective last pages of electronic book files which have been read or used by the specific user on the electronic reader.

6. An electronic reader, comprising:
a recognition unit recognizing an identity input,
wherein the electronic reader outputs a signal for displaying page of an electronic book file previously read on the electronic reader by a specific user and corresponding to the identity input after the recognition unit identifies the identity input.

7. The electronic reader as claimed in claim 6, wherein the recognition unit is one selected from a group consisting of a fingerprint recognition unit, a voice recognition unit, an image recognition unit, a password recognition unit and a combination thereof.

8. The electronic reader as claimed in claim 6, wherein the identity input is one selected from a group consisting of a fingerprint, a voice, an image, a password and a combination thereof.

9. An electronic reader, comprising:
a recognition unit recognizing an input,
wherein the electronic reader outputs a signal for displaying at least one page of an electronic book file read by a specific user and corresponding to the input on the electronic reader after the recognition unit identifies the input.

10. The electronic reader as claimed in claim 9, wherein the at least one page displays a last page of the electronic book file read by the specific user on the electronic reader at the last time.

11. The electronic reader as claimed in claim 9, wherein the at least one page displays respective last pages of electronic book files which were read by the specific user on the electronic reader.

12. A method of displaying, comprising steps of:
providing an electronic reader displaying an electronic book file;
inputting an identify recognition to the electronic reader; and
displaying at least one page of the electronic book file previously used by a specific user in response to the identify recognition on the electronic reader.

13. A method of displaying, comprising steps of
receiving an input through an electronic reader;
opening the electronic reader through the input; and
displaying a page of an electronic book file which was read by a specific user in response to the input, on the electronic reader.
